(19) United States
(12) Patent Application Publication
(10) Pub. No.: US 2010/0114659 A1
(43) Pub. Date: May 6, 2010

(54) MINING PUBLIC MEDIA FOR CONSUMER RESPONSE INFORMATION

(75) Inventors: Kurt D. Newman, Matthews, NC (US); Debashis Ghosh, Charlotte, NC (US); Timothy J. Bendel, Charlotte, NC (US); David Joa, Pacifica, CA (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/263,561

(22) Filed: Nov. 3, 2008

(51) Int. Cl. G06Q 10/00; G06Q 50/00; G06Q 30/00

(52) U.S. Cl. 705/10; 705/11

(57) ABSTRACT

Systems and methods for inferring the success or failure of a third-party Marketing Effort Assays (MEAs) from the marketing efforts of that third party which follow up on the MEA are provided. The system may involve identifying Initial MEA Marketing Efforts (IMEs) by the use of keyword analysis, maintaining a database of such marketing efforts, and comparing those IMEs to later-observed follow-up marketing efforts. The system may further involve establishing geographically or demographically similar peer groupings and applying the inferred success or failure of the MEAs in one such peer group member to another such peer group member.

### FIELD OF TECHNOLOGY

Aspects of the disclosure relate to marketing analysis and competitive intelligence.

### BACKGROUND

Businesses or other entities attempting to sell products and services engage in marketing efforts to distribute messages and encourage sales.

Such marketing efforts may include the purchase of advertising.

Before committing money or resources to such marketing efforts, such businesses may implement Marketing Effectiveness Assays (MEAs). An MEA may demonstrate marketing effectiveness adequate or sufficient to justify the entity's expenditures on that marketing effort and/or sufficient to justify further expenditures by that entity on that marketing effort.

For the purposes of this application, an MEA is “successful” when it demonstrates such adequate or sufficient marketing effectiveness, and an MEA is “unsuccessful” or “fails” when it demonstrates marketing effectiveness insufficient or inadequate to justify current or future expenditures on that marketing effort.

For the purposes of this application, an MEA is “informative” when it demonstrates marketing effectiveness in a manner sufficient for an entity to draw some conclusion as to the success or failure of that MEA.

An MEA may be informative whether or not it is successful or unsuccessful.

For example, an entity may engage in the purchase of advertising as a marketing effort. Before committing significant resources to the purchase of substantial media exposure, the entity may implement the contemplated advertising on a smaller scale, and apply an MEA to that small-scale advertising.

If the MEA is informative, the MEA may also be successful, in that it demonstrates to the entity additional sales observed in response to the advertising, justifying the expenses already incurred in that advertising and justifying the entity's maintaining, or, possibly, increasing the scale of, that advertising campaign in the future.

One of the obstacles to MEA informativeness may present where the marketing message delivery is not contained within a relatively short time window.

For example, advertisements in magazines do not deliver messages when the magazine is distributed; rather, the message is delivered when the recipient reads the magazine. Internet advertising, on the other hand, may deliver messages to the recipient in a much shorter time frame.

When the window of time in which the potential customer is exposed to the marketing message is a broad window, it is difficult to correlate increases (or decreases) in sales to the consumer's exposure to the marketing. The effect of the marketing on consumer behavior (the “response rate”) may be diluted over an extended time.

On the other hand, where the exposure of the relevant consumer to the marketing effort is constrained in time, the response rate is not diluted over time and any MEA applied thereto is more likely to be informative.

Among print media, newspapers present a context for relatively constrained marketing efforts, because the exposure to the relevant consumer is most likely to occur within a very short period of time. Thus, the relevance and usefulness of print newspapers is relatively constrained in time.

Radio and Television advertisements, similarly, lend themselves to informative MEAs, because the time of exposure to the marketing is relatively constrained. Radio and Television advertisements are generally more expensive than newspaper placements, and as such a commensurately larger positive response rate is required for an MEA to be successful.

Conventionally, MEAs are applied by an entity only to marketing efforts originated by that entity or a related entity.

Similarly, investment and credit risk decisions with regard to marketing efforts are based on MEAs and MEA histories applicable to the specific entity or related entities.

The perception by an entity of informative MEAs undertaken by other, unrelated entities would conserve resources and provide a substantial strategic benefit.

It is desirable, therefore, to provide a method or system for observing informative MEAs engaged in by third parties.

### SUMMARY OF THE INVENTION

It is an object of this invention to provide a method or system for observing informative MEAs applied by third parties.

Systems and methods for inferring the success or failure of a third-party MEA from the marketing efforts of that third party which follow up on the MEA is provided.

The method may proceed in three broad steps. First, initial marketing efforts (IMEs) may be detected and/or identified.

Second, the third-party follow up marketing efforts (FUMEs) may be detected and/or identified.

Third, inference may be drawn from the FUMEs as to the success or failure of MEAs applied to the IMEs.

As noted, marketing efforts may include advertising, such as newspaper, radio, television, internet, and podcast advertising.

In one embodiment, the process may include monitoring advertisements for key words or phrases selected for relevance to the interests of the monitoring entity.

Monitoring advertisements in print media may be done by text mining software or algorithms; monitoring advertisements in radio or television may require voice-to-text conversion followed by analysis by text mining software.

Once the process determines that some monitored advertisement is an IME, the process may monitor future advertisements for other advertisements connected to the same originating entity or good or service with similar keyword placement.

On encountering such other advertisements, the process may further determine by comparison of the scope of a set of advertisements or the geographic target of an advertisement that these later advertisements are FUMEs.

The process may then determine that the FUMEs demonstrate justification of the IME, and that the MEA related to the advertisements was both informative and successful.

The process may alternately encounter a sharp drop-off or even complete absence of FUMEs, in which case the process may determine that the MEA was unsuccessful.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a computing device for implementing an embodiment of the invention;

FIG. 2 is a flow diagram demonstrating an aspect of the process in accordance with the principles of the invention;

FIG. 3 is a flow diagram that continues from the flow diagram shown in FIG. 2; and

FIG. 4 is a flow diagram that continues from the flow diagram shown in FIG. 3.

### DETAILED DESCRIPTION OF THE INVENTION

Methods and systems for inferring the success or failure of a third-party MEA from the marketing efforts of that third party which follow up on the MEA are provided.

As noted, the method may proceed in three steps: identifying the IMEs, identifying the FUMEs, drawing the inferences therefrom.

In one embodiment, keywords may be identified and/or received. Such keywords may be used to identify marketing efforts relevant to the interests of the practicing entity.

The marketing efforts may include advertisements on television, radio, or in newspapers.

The keywords, for example, may include phrases such as “debt reduction/consolidation/elimination” or “bankruptcy assistance” or “foreclosure avoidance.”

The keywords may include phrases of other types, such as “home improvement” or “deck repair/replacement” or “lawn care.” Use of such keywords may be premised on a logical derivation, reading the advertisement to include availability of services and the availability of services to speak to the lack of other engagements by the providers of those services.

Advertisements may then be observed in public media. Observation of advertisements in different media may be standardized for access and analysis.

For example, the audio component of some advertisements may be converted to text by speech recognition, the video component of some advertisements may be converted to text by image recognition, and text components may be unchanged so as to standardize all the advertisements into text suitable for text mining.

A database of those observed advertisements and information relating to those advertisements may be created.

Through the use of text mining procedures, the first few occurrences of any particular keyword sequence may be observed.

Information about those occurrences may be recorded. Such information may include information sufficient to identify the product or service advertised, the advertiser, the geographic scope of the advertisement, the apparent demographic target of the advertisement, and/or the creator of the advertisement.

For the purposes of this application, the creator of the advertisement may be the advertising agency or marketing department responsible for the actual content of the advertisement, as opposed to the advertiser, which may be the entity benefiting from the advertisement.

In certain embodiments of the invention, the recorded occurrences may be reviewed in order to categorize each advertisement and determine if any particular advertisement is one that should be monitored.

Those advertisements designated for monitoring may form a set of advertisements defined above as the IMEs. The IMEs may be recorded in a database.

Further advertisements may then be observed in public media.

For the purposes of this application, a marketing effort later in time is said to “follow up” on a marketing effort earlier in time if an MEA applied to the marketing effort earlier in time is used to justify the expenditure of money or resources on the marketing effort later in time.

Through the use of text mining and other comparative procedures, advertisements following up on an identified IME may be identified. The advertisements so identified are can preferably be defined as the FUMEs.

The analyst may establish a metric for follow-up advertising such that follow-up advertising that meets or exceeds the metric may be considered “significant,” and follow-up advertising that fails to meet the metric may be considered “insignificant.” Alternatively, the metric for follow-up advertising may be set to a numeric scale and a numeric threshold may be used to determine the significance of the follow-up advertising.

Such metrics may include the number of advertisements placed, or the amount of time purchased and/or taken by the advertisements, or an approximation of the value of the advertisements.

If the FUMEs are significant, the analyst may infer that the MEA as applied to the relevant IMEs was successful.

Further, in some embodiments, peer groups of some geographic regions may be created, based on both traditionally available demographics and perceived MEA responses for other advertisements.

For example, City A may be deemed a peer geographic region to City B, where City B and City A have similar demographic makeups and where an MEA relating to advertisements for some other product was successful in both City B and City A.

In some instances, the third party engaging in the perceived/inferred MEA may constrain both the IMEs and FUMEs to one geographic region. The establishment of peer geographic regions may allow a prediction of a successful MEA against the same IME in another, peer geographic region.

For instance, if an IME is observed in City A, followed by significant FUME in City A, leading to the inference of a successful MEA applied to the IME in City A, the prior establishment of City B as a peer geographic region allows for the prediction that the MEA applied to the same IME in City B would be successful.

In some embodiments, the MEA results may be collected in a database and that database is analyzed to better understand and predict consumer behavior.

In some embodiments, access to the raw data is offered for sale to merchants and investors.

In some embodiments, a financial entity may use the database and analysis to refine investment decisions, enhance risk management practices, and/or strategic planning.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

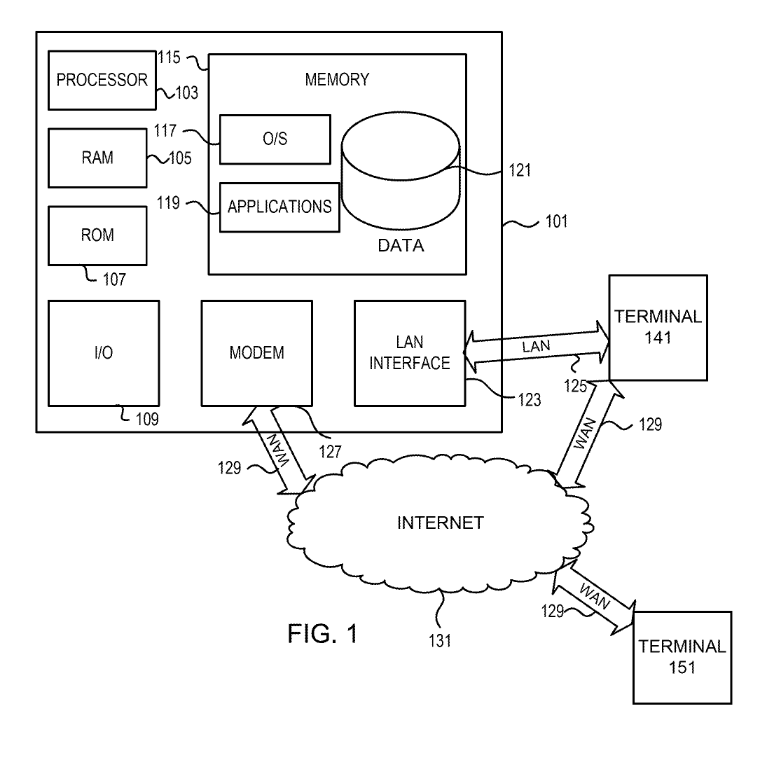

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 201 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

One or more of applications 119 may include one or more algorithms for voice recognition, text mining, or other suitable subjects.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

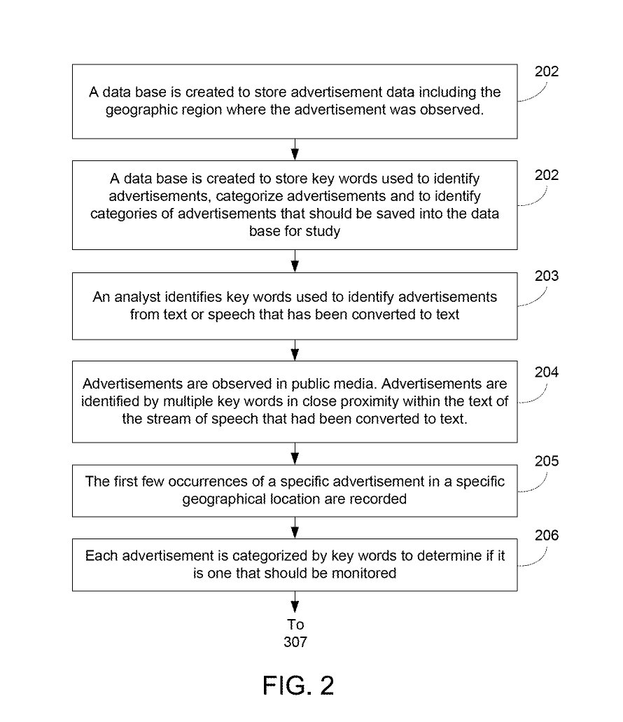

FIG. 2 is a flow diagram demonstrating an aspect of the process in accordance with the principles of the invention.

The System Flow 200 demonstrates one exemplary embodiment of the invention.

In Step 201, a database is created to store advertisement data and information related to that advertisement including, for example, the geographic region where the advertisement was observed.

In Step 202, a database is created to store keywords used to identify advertisements, categorize advertisements, and to identify categories of advertisements that could be saved into the database for study.

An analyst identifies key words used to identify advertisements 203. Advertisements are then observed in public media and identified by the keywords 204. In one embodiment of the invention, advertisements can be identified by multiple key words in close proximity within the stream of speech that had been converted to text.

The first few occurrences of a specific advertisement in a specific geographic location may be recorded 205. The advertisement is categorized by keywords to determine if it should be monitored further 206.

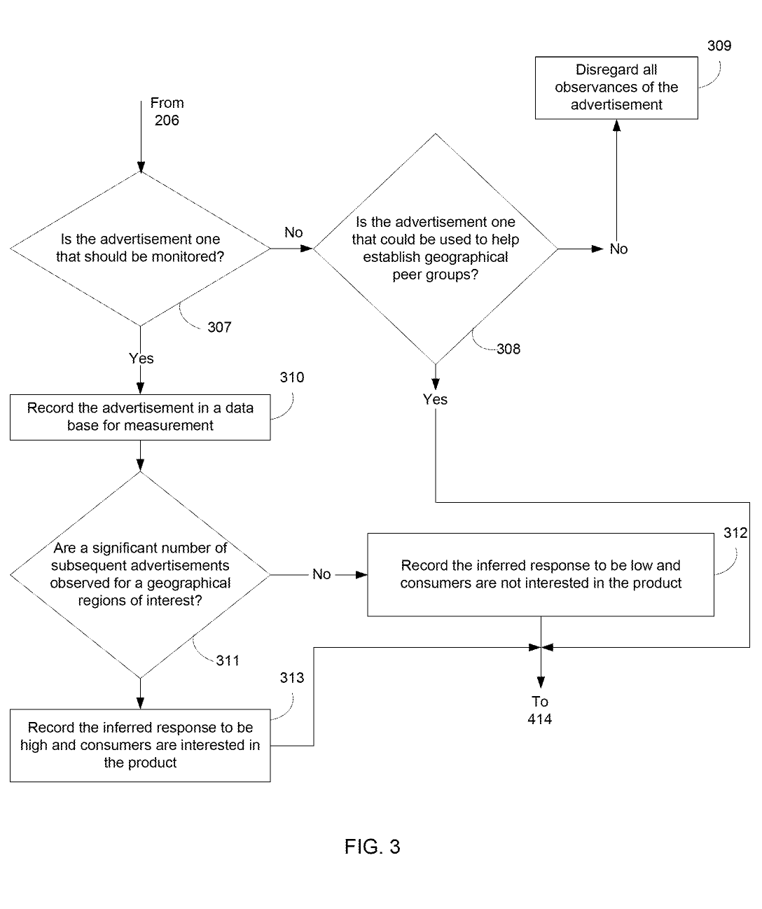

FIG. 3 shows a continuation of the flow diagram of FIG. 2. If the advertisement is not one that should be monitored further 307, the determination is made as to whether or not the advertisement is one that could be used to help establish geographic peer groups 308.

If the advertisement is not one that could be used for that purpose, it is disregarded going forward 409.

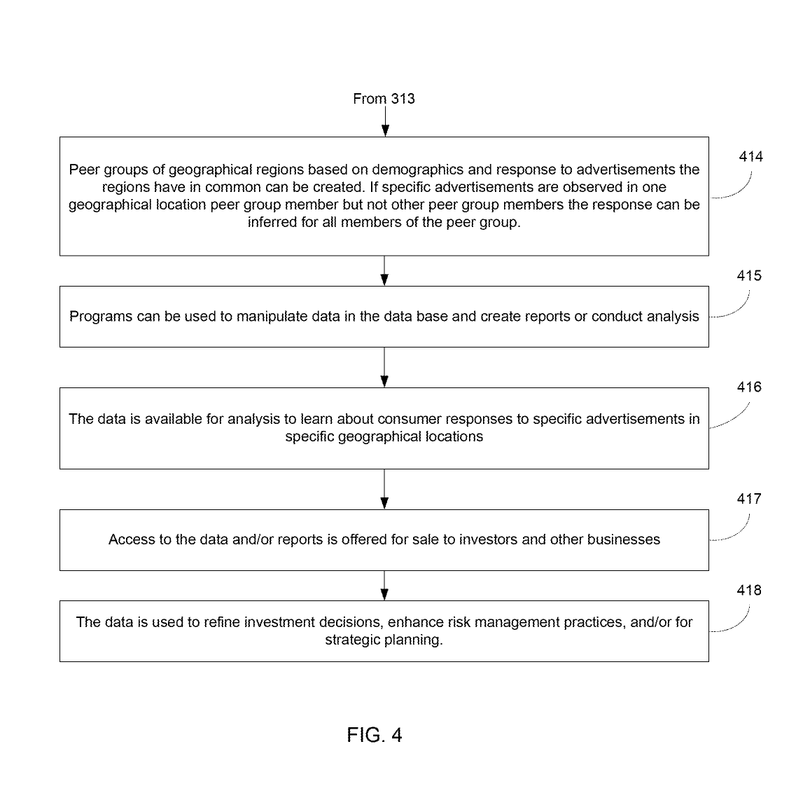

If the advertisement is one that could be used for that purpose, the advertisement is used to define geographic peer groups (this branch preferably continues to element 414 in FIG. 4).

If the determination is made that the advertisement is one that should be monitored 107, it is recorded in a database for metrics and future monitoring 110.

The determination is then made as to whether or not a significant number of advertisements are observed within the geographic regions of interest 311.

If the number of advertisements is significant, the inferred response is deemed high and the MEA is inferred to be successful 313. If that number is not significant, the inferred response is deemed low and the MEA is inferred to be unsuccessful 312.

In either instance, the geographic peer groups may be created (this branch preferably continues to element 414 in FIG. 4).

FIG. 4 shows a continuation of the flow chart in FIG. 3. MEA success or failure relevant to specific advertisements observed in one peer group member but not in others may be inferred to those others 414.

The data in the database may be manipulated and reports and analysis may be conducted 415.

The data may be made available for analysis 416.

Access to the data or reports may be offered for sale to investors and other businesses 417.

The data may be used to refine investment decisions, enhance risk management practices, and/or for strategic planning 418.

Thus, systems or methods for inferring the success or failure of a third-party MEA from the marketing efforts of that third party which follow up on the MEA are therefore provided. Persons skilled in the art will appreciate that the present invention can be practiced by other than the described embodiments, which are presented for purposes of illustration rather than of limitation, and that the present invention is limited only by the claims that follow.

What is claimed is:

1. A system for inferring the success or failure of a marketing effectiveness assay, the system configured to:
identify third-party initial marketing effort;
identify follow-up marketing efforts relevant to said initial marketing efforts; and
infer the success or failure of a third party marketing effectiveness assay relevant to the initial marketing efforts from the presence or absence of the follow-up marketing efforts.

2. The system of claim 1, wherein identifying third-party initial marketing efforts further comprises determining keywords relevant to marketing efforts of interest.

3. The system of claim 1, wherein identifying third-party initial marketing efforts further comprises observing public marketing efforts.

4. The system of claim 1, wherein identifying third-party initial marketing efforts further comprises identifying the source of the marketing efforts.

5. The system of claim 1, wherein identifying follow-up marketing efforts relevant to the initial marketing efforts further comprises determining keywords relevant to marketing efforts of interest.

6. The system of claim 5, wherein identifying follow-up marketing efforts relevant to the initial marketing efforts further comprises observing public marketing efforts.

7. The system of claim 6, wherein identifying follow-up marketing efforts relevant to the initial marketing efforts further comprises identifying the occurrence of keywords in the observed marketing efforts.

8. The system of claim 7, wherein identifying follow-up marketing efforts relevant to the initial marketing efforts further comprises correlating the marketing efforts observed later in time with those identified earlier in time.

9. The system of claim 1, wherein inferring the success or failure of the third-party MEAs further comprises establishing a threshold metric by which to measure the resources invested by a third-party into that party's marketing efforts.

10. The system of claim 9, wherein identifying follow-up marketing efforts relevant to the initial marketing efforts further comprises applying the standard of that metric to the observed FUMEs.

11. The system of claim 1 further configured to identify groups of consumers of marketing efforts.

12. The system of claim 11 further configured to identify groups of such consumers that are similar to each other.

13. The system of claim 12 further configured to predict from the inferred success or failure of the marketing effectiveness assay as directed to one group the likely success or failure of a similar marketing effectiveness assay as directed to another group.

14. One or more computer-readable media storing computer-executable instructions which, when executed by a processor on a computer system, perform a method for inferring the success or failure of a third-party marketing effectiveness assay, the method comprising:
identifying third-party initial marketing effort;
identifying follow-up marketing efforts relevant to said initial marketing efforts; and
inferring the success or failure of a third-party marketing effectiveness assay relevant to the initial marketing efforts from the presence or absence of the follow-up marketing efforts.

15. The method of claim 14, wherein identifying third-party initial marketing efforts further comprises determining keywords relevant to marketing efforts of interest.

16. The method of claim 14, wherein identifying third-party initial marketing efforts further comprises observing public marketing efforts.

17. The method of claim 14, wherein identifying third-party initial marketing efforts further comprises identifying the source of the marketing efforts.

18. The method of claim 14, wherein identifying follow-up marketing efforts relevant to the initial marketing efforts further comprises determining keywords relevant to marketing efforts of interest.

19. The method of claim 18, wherein identifying follow-up marketing efforts relevant to the initial marketing efforts further comprises observing public marketing efforts.

20. The method of claim 19, wherein identifying follow-up marketing efforts relevant to the initial marketing efforts further comprises identifying the occurrence of keywords in the observed marketing efforts.

21. The method of claim 20, wherein identifying follow-up marketing efforts relevant to the initial marketing efforts further comprises correlating the marketing efforts observed later in time with those identified earlier in time.

22. The method of claim 14, wherein inferring the success or failure of the third-party marketing effectiveness assay further comprises establishing a threshold metric by which to measure the resources invested by a third-party into that party's marketing efforts.

23. The method of claim 22, wherein identifying follow-up marketing efforts relevant to the initial marketing efforts further comprises applying the standard of that metric to the observed follow-up marketing efforts.

24. The method of claim 14 further configured to identify groups of consumers of marketing efforts.

25. The method of claim 24 further configured to identify groups of such consumers that are similar to each other.

26. The method of claim 25 further configured to predict from the inferred success or failure of the marketing effectiveness assay as directed to one group the likely success or failure of a similar marketing effectiveness assay as directed to another group.
